(19) United States
(12) Patent Application Publication
(10) Pub. No.: US 2002/0092018 A1
(43) Pub. Date: Jul. 11, 2002

(54) Reusing the same hardware platform by loading different application software from a memory stick

(76) Inventors: Shobana Biederman, San Jose, CA (US); Damien Kessler, San Jose, CA (US); Said Jackson, Cannes (FR)

Correspondence Address: WAGNER, MURABITO & HAO LLP, Third Floor, Two North Market Street, San Jose, CA, 95113, US

(21) Appl. No.: 09/727,192

(22) Filed: Nov. 29, 2000

(51) Int. Cl. G06F 9/455; H04N 5/445; G06F 13/00; G06F 3/00

(52) U.S. Cl. 725/37

(57) ABSTRACT

The present invention provides a system, method, and apparatus for providing enhanced functionality to a digital terminal device, such as a set top box configured with a default application program. In one embodiment, the present invention is comprised of a media receiving apparatus. The media receiving apparatus is communicatively coupled to and is integral to the form factor of a set top box. In the present embodiment, the media receiving apparatus is adapted to receive a digital storage media, such as a memory stick. In the present embodiment, the media receiving apparatus is further comprised of an accessing mechanism coupled to the media receiving apparatus. The accessing mechanism is adapted to access the data disposed within a received digital storage media. In the present embodiment, the present invention is further comprised of a relaying mechanism coupled to the media receiving apparatus. The relaying mechanism is adapted to relay the data contained within a digital storage media to a digital terminal device, such as a set top box. In the present embodiment of the present invention, the data contained within the digital storage media is an alternative application software program, configured as a stand-alone, corrective, or upgrade application program to be utilized in a digital terminal device such as a set top box.

### FIELD OF THE INVENTION

The present invention relates to digital terminal devices, also called intelligent transceivers or set top boxes, specifically with regard to bi-directional set top boxes. More particularly, the present invention provides enhanced functionality for a set top box by utilizing digital storage media.

### BACKGROUND OF THE INVENTION

With the continuing increase in the development of digital communication and the acceptance and use of digitized information in a digital broadcast system, digital television is becoming as prevalent as analog television as a broadcasting communication medium.

Digital broadcast systems include direct broadcast digital satellite systems, interactive World Wide Web access systems, and digital cable systems. Digital broadcasting provides a number of advantages to subscribers, such as variety and flexibility of programming, useful and comprehensive support services (such as detailed electronic programming guides), superior audio and video quality, compatibility with computers and the Internet, and consistency of reception over varying distances. Further, with the development and acceptance of digital television, other related products to be implemented in conjunction with this new television medium have been developed and made available to the consumer. One such product developed for use with new television medium is the intelligent transceiver, commonly referred to as a digital terminal device or a set top box. Subscribers receive broadcast digital signals via set-top boxes or other similar consumer electronic equipment (generally, a “transceiver”) located in the subscriber's home. In an intelligent set-top box, information and instructions associated with receiving and processing digital broadcast signals are stored in a memory unit of the set-top box and executed by a processor.

FIG. 1 (Prior Art) is a block diagram illustration of certain components contained within and associated with exemplary digital terminal devices, such as set top boxes. Digital terminal device 100 is pictured as having boot loader 102 (read only memory containing initial start-up instructions), flash memory 104 (non-volatile memory containing the application software), SDRAM 106 (synchronous dynamic random access memory), and CPU 108 (central processing unit/processor) all communicatively coupled through bus 110. Central processing unit 108 also may contain random access memory, read only memory, one or more caches, a flash memory and the like (not shown) for storing information and instructions.

Still referring to FIG. 1(Prior Art), when power is applied to the set top box, the initial start-up instructions contained within boot loader 102 instruct processor 108 to access the application software disposed within flash memory 104. Processor 108 then copies the application software contained within flash memory 104 to SDRAM 106 where it is stored in the appropriate memory locations. From this junction, processor 108 then accesses the information in SDRAM, processes the instructions and relays the processed data to graphic block 115 which then relays the data to display 120 for viewing by a user.

A set-top box performs a number of functions associated with processing a broadcast digital signal. Typically, the digital signal received by the set-top box is encoded, and the signal is decoded by the set-top box before further processing occurs. The decoded signal is then encrypted within the set-top box in order to prevent unauthorized duplication and use (“pirating”) of the decoded signal. Once the encrypted signal is at a more secure location within the set-top box, it is decrypted for further processing. The digital signal is typically in a compressed data format such as MPEG (Moving Picture Experts Group) for video signals and/or Dolby AC3 for audio signals, and so the decrypted signal is decoded (uncompressed) by the set-top box. After decoding, the audio content and video content contained in the digital signal are processed so that it can be viewed and/or listened to by the subscriber using, for example, a television set.

A digital terminal device, such as a bi-directional set top box is designed to provide interactivity between the subscriber and the digital broadcast system operator (commonly known as the MSO, or Multiple System Operator). The bi-directional capabilities of the set top box provides a subscriber many different options and functions from which to select. A subscriber may select a premium service offered by the MSO, such as a pay-per-view movie or event. A subscriber may chose to watch a television show that includes viewer interactivity, such as a game show or a quiz show. The subscriber may, while watching a sporting event, utilize the instant replay capability of the bi-directional set top box. A subscriber may wish to see the provided electronic programming guide for the week, and predetermine which, if any, shows they might want to view. Other options and functions include accessing the Internet, listening to a variety of available music, and the like.

As one could anticipate, the growth of digital terminal devices has further spawned an influx in new applications being designed for use in conjunction with bi-directional set top boxes. Some of the applications being developed include advanced graphic production, video-on-demand and near-video-on-demand, and enhanced music and video entertainment. Others are addressing the field of finance, with applications being developed for such categories as banking, bill paying, stock and mutual find purchasing and trading. Still others are developing applications for shopping, e.g., store catalogs, merchant web pages, on-line malls, and such.

The advantages described above provide an enhanced viewing experience to a subscriber using a set top box. However, certain physical limitations and disadvantages inherent to the set top box with regard to memory and storage have become apparent. By design, memory and storage (RAM and hard drives) quantities, normally associated with a full-sized computer system, have been reduced, and in some instances, eliminated. To function within the described design limitations, most set top boxes provide a subscriber with a limited number of applications. Since the reduced capacities of the set top box prohibit a large variety of applications to be stored within the set top box itself, a way is desired to provide additional applications for use in a set top box is needed.

Further, with new applications being developed, those applications that are released will, in most circumstances, contain bugs. Bugs are a collective term for glitches in the application's programming, or code, that prevents the application from functioning properly. To repair a bug, a portion of corrective programming is needed and must be installed into the application's original programming. Additionally, those applications that are, or will be, used will, in most circumstances, need to have their original programming periodically updated or upgraded. This upgrading may be due in part to technological advances of the components associated with the set top box, e.g., new satellite technology, new broadband techniques, and the like. Or, the upgrading may be due in part to new functionalities being implemented in that particular application that would better serve a subscriber. Since most subscribers will not want to take the set top box to the dealer for either the installation of the correcting programming or for the upgrade, a way is desired to perform the correction or upgrade without requiring the subscriber to return the unit to the dealer.

Therefore, there exists a need for a system, method, and apparatus for loading and utilizing additional applications. Another need exists for a system, method, and apparatus that provides an easy and convenient means to install corrective programming and/or upgrades to existing programming. Further, there exists a need for a system, method, and apparatus that is adaptable to existing hardware configurations. The present invention provides a unique and novel solution to those and other problems.

### SUMMARY OF THE INVENTION

Accordingly, the present invention provides a system, method and apparatus for providing enhanced functionality to a digital terminal device, such as a set top box. The present invention further provides a means to utilize a media storage device, such as a memory stick. In the present invention, a media storage device, such as a memory stick, is used to implement alternative application software programs in a digital terminal device, such as a set top box. In the present invention, by using the memory stick, a set top box can be operated with a stand-alone application software program other than the default application program with which it was originally configured. In the present invention, by using the memory stick, the set top box's default application program with which it was originally configured can be upgraded or corrected without requiring a user to return to the dealer for that service to be provided. Further, by using the memory stick in the present invention, the stand-alone, upgrade, or corrective application software program can be utilized without reconfiguration of the existing hardware contained within the set top box.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 (PRIOR ART) is a block diagram illustration of certain components in an exemplary digital terminal device.

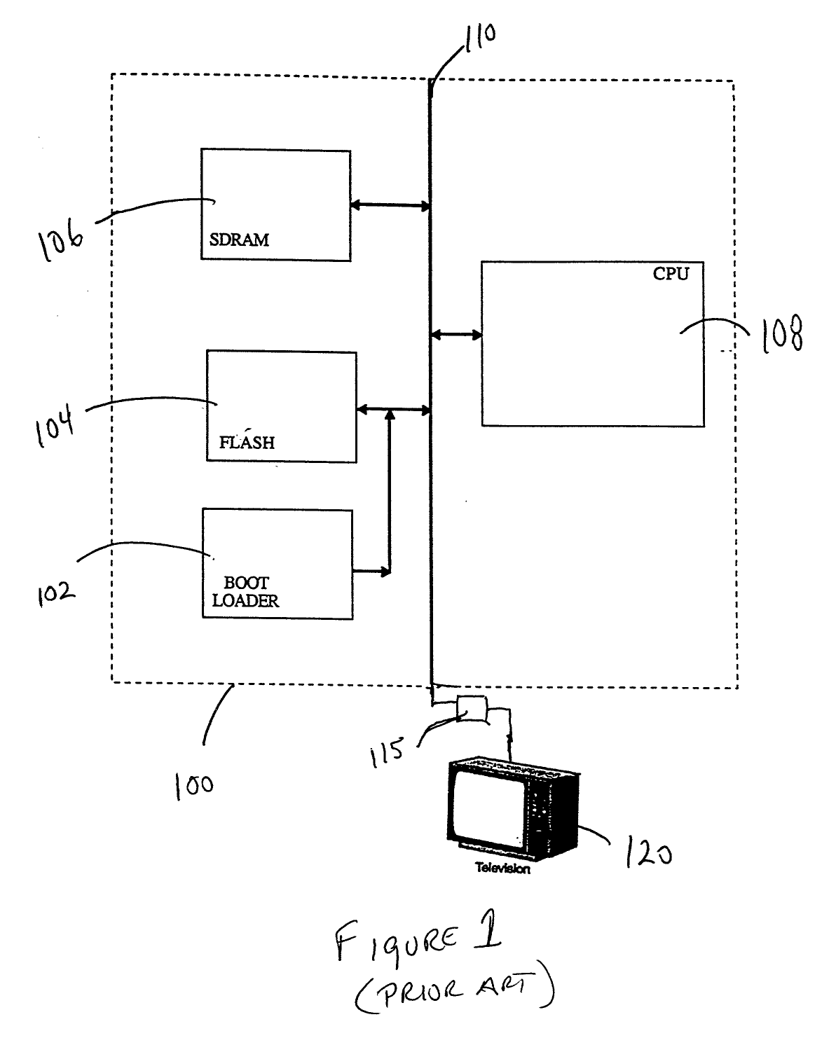

FIG. 2 is a block diagram illustration of certain components in a digital terminal device configured with a media receiving apparatus, in accordance with one embodiment of the present invention.

FIG. 3 is a block diagram illustration of certain components in a digital terminal device configured with a media receiving apparatus and shown with inserted digital storage media, in accordance with one embodiment of the present invention.

FIG. 4 is a block diagram illustration of a memory address configuration of flash memory disposed within a digital terminal device configured with a media receiving apparatus with respect to a boot loader program and an application program contained within the flash memory, in accordance with one embodiment of the present invention.

FIG. 5 is a block diagram illustration of a memory address configuration of SDRAM disposed within a digital terminal device configured with a media receiving apparatus with respect to a boot loader program and an application program loaded from flash memory into SDRAM, in accordance with one embodiment of the present invention.

FIG. 6 is a front-view illustration perspective of a digital terminal device configured with a media receiving apparatus, in accordance with one embodiment of the present invention.

FIG. 7 is a flowchart showing the steps in a process 700 for utilizing a media receiving apparatus to enhance the functionality of a digital terminal device, in accordance with one embodiment of the present invention.

### DETAILED DESCRIPTION

A media receiving apparatus is described. In the following description, for purposes of explanation, numerous specific details are set forth in order to provide a thorough understanding of the present invention. It will be obvious, however, to one skilled in the art that the present invention may be practiced without these specific details. In some instances, well-known structures and devices are shown in block diagram form in order to avoid obscuring the present invention. In other instances, well know methods, procedures, components, and circuits have not been shown or described in detail so as not to unnecessarily obscure aspects of the present invention.

### Notation and Nomenclature

Some portions of the detailed descriptions, which follow, are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining” or “indicating” or “indexing” or “receiving” or “performing” or “initiating” or “sending” or “implementing” or “disabling” or “enabling” or “displaying” or “relaying” or “copying” or “loading” or “executing” or the like, refer to the action and processes of a computer system or similar electronic computing device, that manipulates and transforms data represented as physical (electronic) quantities within the computer system's registers and memories into other data similarly represented as physical quantities within the computer system memories or registers or other such information storage, transmission or display devices.

The present invention, a media receiving apparatus, is discussed primarily in the context of a digital terminal device, such as an intelligent transceiver or a bi-directional set top box. However, it is appreciated that the present invention can be used with other types of devices that have the capability to access digital storage media, including but not limited to digital terminal devices, such as set top boxes.

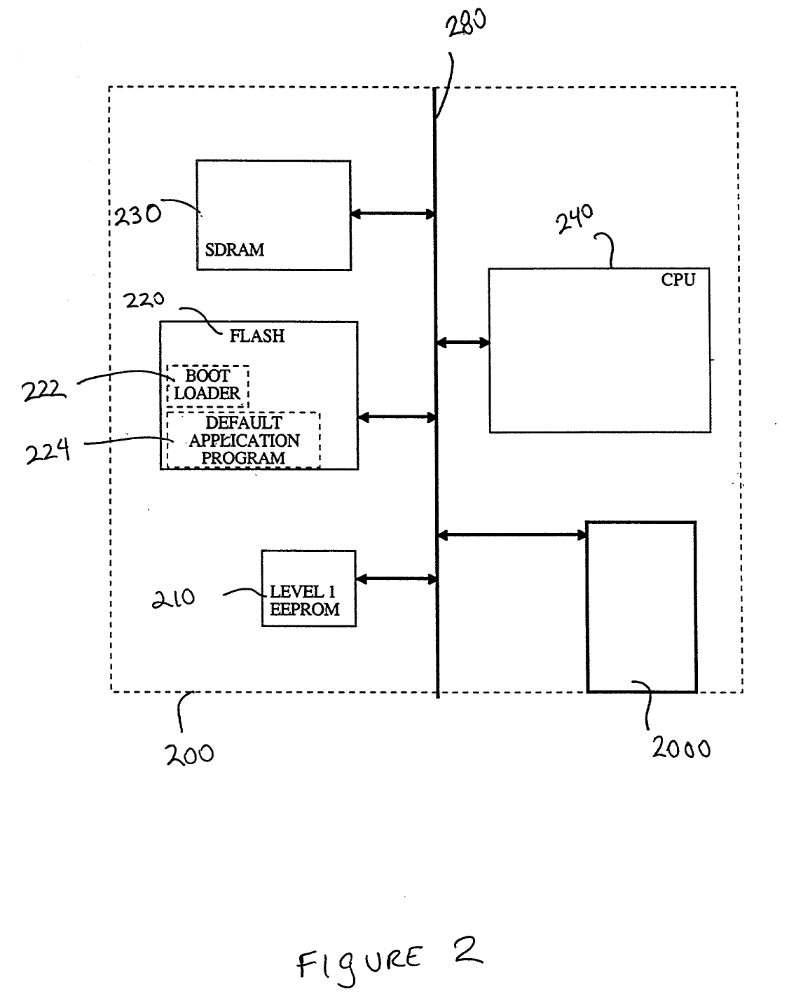

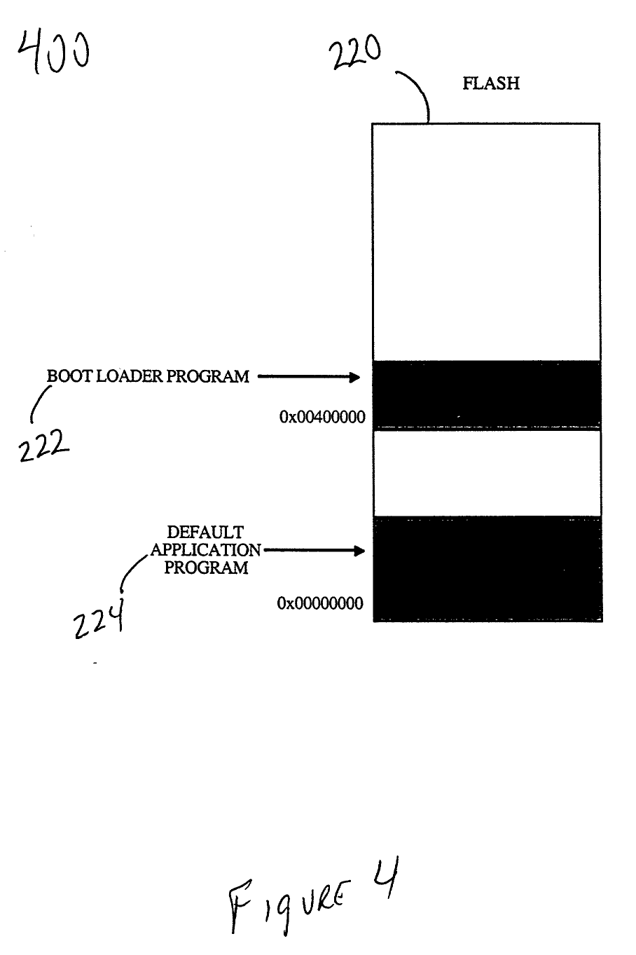

FIG. 2 is a block diagram illustration of a digital terminal device, such as a set top box, configured with a media receiving apparatus, in one embodiment of the present invention. Starting from the lower left and proceeding in a clockwise manner, shown is set top box 200 as indicated by a dotted line. Level 1 EEPROM (electrically erasable programmable read only memory) 210 is shown as coupled to bus 280. Level 1 EEPROM 210 contains those instructions needed to initiate the first step in the two step process of booting-up the set top box. Flash memory 220 is shown as coupled to bus 280. Flash memory 210 contains boot loader program 222 and default application program 224. Boot loader program 222 contains the instructions that enable the second step of the two step boot process. Default application program 224 is the application that is loaded when no other application is present or that can be loaded from the media storage device. Please refer to FIG. 4, one embodiment of the present invention, for a description and explanation of the addressable memory locations of boot loader program 222 and default application program 224 contained within flash memory 220 of set top box 200. SDRAM 230 is shown as coupled to bus 280. SDRAM (synchronous dynamic random access memory) 230 is a configuration of memory cells that contain data for processing by the processor. CPU (central processing unit) 240 is shown as coupled to bus 240. CPU 240 executes the program instructions stored in the addressable memory locations within SDRAM 230. Media receiving apparatus 2000 is shown as coupled to bus 280.

It should be appreciated that bus 280 is an internal address/data bus for communicating digital information between the components of set top box 200. In one embodiment, bus 280 is a high bandwidth bus, for example a Peripheral Component Interconnect (PCI) bus.

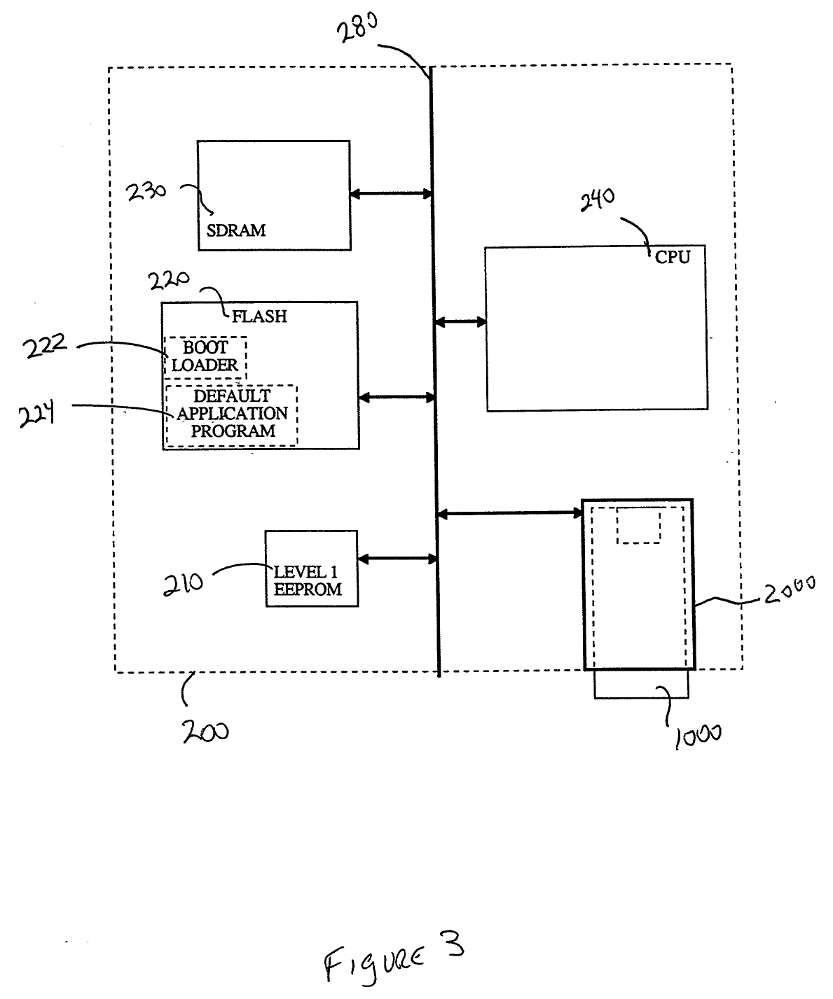

FIG. 3 is a block diagram illustration of a digital terminal device, such as a set top box, configured with a media receiving apparatus in one embodiment of the present invention. In the current embodiment of the present invention, set top box 200 is depicted as configured with media receiving apparatus 2000. Media storage device 1000 is shown as having been inserted into media receiving apparatus 2000. In one embodiment, media storage device 1000 may be a memory stick. In another embodiment, media storage device 1000 may be a SDC (secure data card). In yet another embodiment, media storage device 1000 may be an MMC (multi media card).

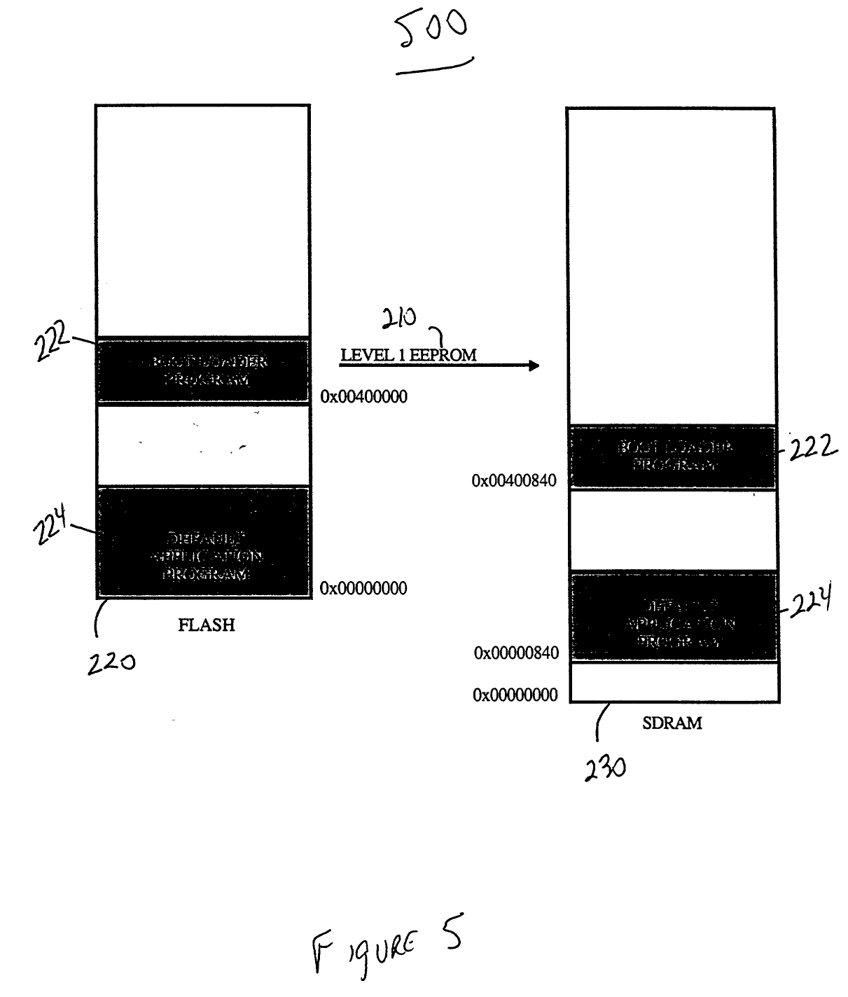

Still with-reference to FIG. 3, in the current embodiment of the present invention, once media storage device 1000 has been inserted into media receiving apparatus 2000, the user then begins the two step process to boot-up set top box 200. To begin, the set top box is turned on. Once power is applied, the contents of Level 1 EEPROM 210, the first-step instructions of the two step boot-up process, gets loaded into SDRAM 230 at Level 1 base address 0x00000000, in this embodiment of the present invention, and hence gets executed. This first-step set of instructions copies the entire content of flash memory 220, or at least the sections that contain boot loader program 222 and default application program 224 into SDRAM 230. Default application program 224 is copied to SDRAM 230 at level 2 base address 0x00000840, in one embodiment of the present invention. Boot loader program 222 is copied to SDRAM 230 at level 2 base address 0x00400840, in one embodiment of the present invention. Please refer to FIG. 5 for a description and explanation of the addressable memory locations in SDRAM 230 where boot loader program 222 and default application program 224 are disposed, in one embodiment of the present invention.

It should be appreciated that flash memory 220, as a whole, is loaded into SDRAM 230 to speed up the boot process of the set top box. It should be further appreciated that flash memory can be written to in block (rather than byte) sizes, whereas RAM needs to be addressable at the byte (rather than block) level. Therefore it is necessary to ensure that the relative location of each binary file in the flash memory must be the same as the corresponding addressable memory location in SDRAM 230.

Still referring to FIG. 3, once the portions of flash memory 220 that contain boot loader program 222 and default application program 224 have been loaded into SDRAM 230, at the previously described locations, level 1 EEPROM 210 then jumps to the start of the boot loader program residing at level 2 base address 0x00400840 memory location of SDRAM 230, in one embodiment of the present invention. Once EEPROM 210 has jumped to the start of boot loader program 222, boot loader program 222 gets executed. It checks to see if media storage device 1000 has been inserted into media receiving apparatus 2000, and if it contains valid alternative application software programs.

In one embodiment, the alternative application software program is a stand-alone application software program to be implemented by the set top box instead of existing default application program 224. In another embodiment, the alternative application software program is an upgrade application software program, designed to be written into existing default application program 224 for improving the functionality thereof. In another embodiment, the alternative application software program is a corrective application software program, designed to overwrite specific portions of default application program 224 that has been determined to contain a bug. A bug, also called a glitch, is a portion of the programming language contained within an application's program that prevents the application from performing as it was originally designed.

It should be appreciated that the binary image of the alternative application software program that needs to be executed must be stored in the root directory of media storage stick 1000, and that it should be called BOOTAPPS.out, in this embodiment of the present invention. It should be further appreciated that the binary file to be executed may be called something other than BOOTAPPS.out, but it should be understood that the programmed instructions contained within boot loader program 222 in flash memory 220 must correspond to the other name given to BOOTAPPS.out.

If boot loader program 222 finds a valid alternative application software program called, in one embodiment, BOOTAPPS.out contained within the root directory of media storage device 1000 which has been inserted into media receiving apparatus 2000, then BOOTAPPS.out is copied into SDRAM 230 at level 2 base address 0x00000480, in one embodiment, which thereby overwrites default application program 224 previously written to the same address. The executing program, disposed at SDRAM addressable memory location 0x00000000, refer to FIG. 5, is instructed to then jump to addressable memory location 0x00000804, which happens to be the start of the application program, either the alternative application software program present in media storage device 1000 or default application program 224 contained within set top box 200 in flash memory 220. It should be appreciated that by virtue of boot loader program 222 being placed into SDRAM 230 at level 2 base address 0x00400840, in one embodiment, it is disposed within the middle of the SDRAM memory space, it will get used as heap, and will therefore be erased.

It should be appreciated that regardless of which application program, either default program 224 or alternative program in media storage device 1000, the user chooses to implement, once it is loaded into SDRAM and executed by the processor, it is sent to the graphic block (not shown) and becomes an interface displayed to the user.

Referring now to FIG. 4 which is a block diagram illustration of a memory address configuration 400 of flash memory 220 disposed within digital terminal device 200 configured with media receiving apparatus 2000 with respect to a boot loader program and an application program contained within the flash memory, in one embodiment of the present invention. Default application program 224 is depicted as being disposed at addressable memory location 0x00000000 of flash memory 220, in one embodiment of the present invention. Boot loader program 222 is depicted as disposed at addressable memory location 0x0040000 of flash memory 220, in one embodiment of the present invention. As previously described, these locations must correspond to the equivalent addressable memory locations of SDRAM 230 into which they will be loaded.

Referring now to FIG. 5 which is a block diagram illustration of a memory address configuration 500 of SDRAM 230 disposed within digital terminal device 200 configured with a media receiving apparatus 2000 with respect to boot loader program 222 and default application program 224 having been copied from flash memory 220 into SDRAM 230, in one embodiment of the present invention. When the contents of flash memory 220, as previously described in FIG. 4 and as shown again on the left, specifically boot loader program 222 and default application program 224, are copied to SDRAM 230, as previously described in the paragraphs regarding FIG. 3 with respect to level 1 EEPROM 210, the addressable memory locations of each are as follows. Boot loader program 222, from addressable memory location 0x00400000 of flash memory 220, is copied to SDRAM level 2 base addressable memory location 0x00400840. Default application program 224, from addressable memory location 0x00000000 of flash memory 220, is copied to SDRAM level 2 base addressable memory location 0x00000804.

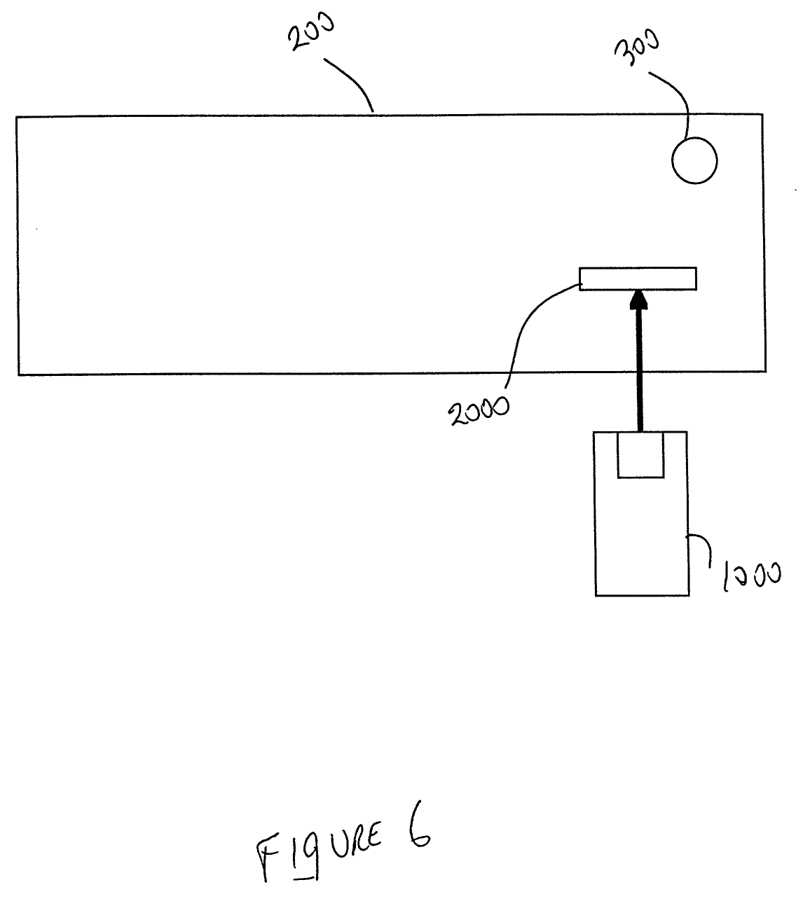

FIG. 6 is representative of digital terminal device 200 configured with media receiving apparatus 2000, in one embodiment of the present invention. Media receiving apparatus 2000 is shown as disposed upon the lower right facial surface of and integral with the form factor of digital terminal device 200. Media receiving apparatus 2000 is shown as adapted to receive media storage device 1000. Power button 300 is shown as disposed upon the upper right facial surface of digital terminal device 200. In this embodiment of the present invention, the depicted and described locations of media receiving apparatus 2000 and power button 300 should not be construed as being definitive or as a limitation as to the disposition thereof, but instead as one example of the numerous possible configurations.

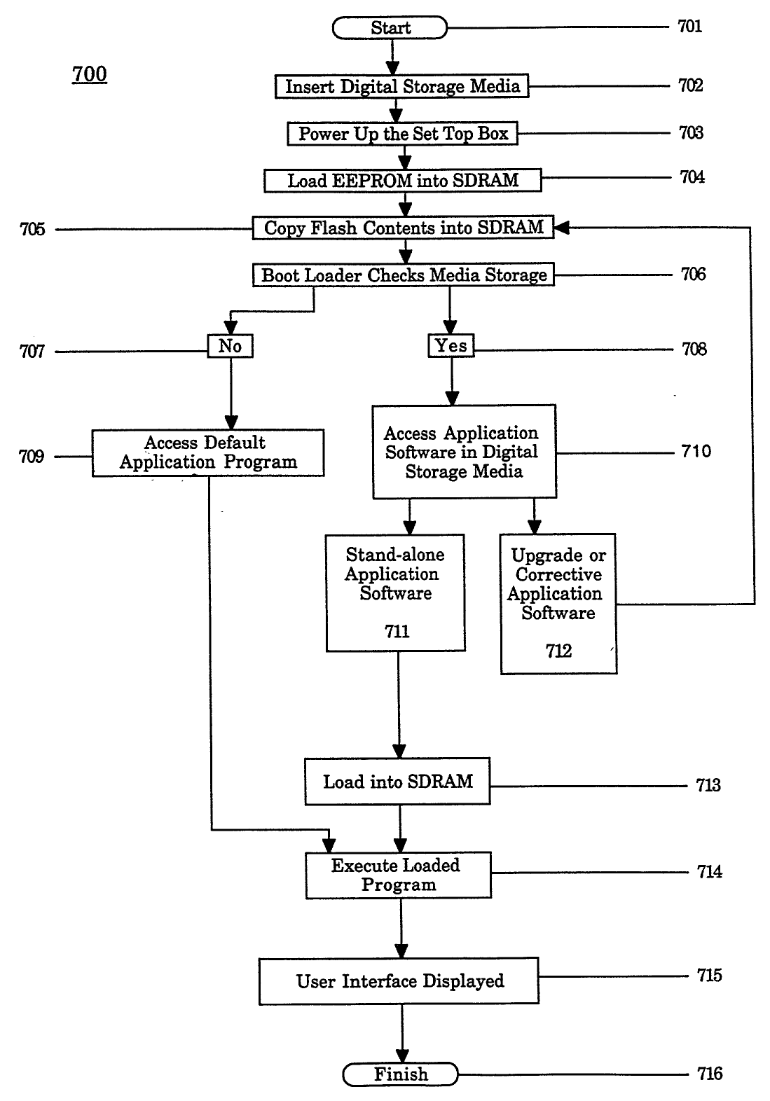

FIG. 7 is a flowchart showing the steps in a process 700 for utilizing media receiving apparatus 2000 to enhance the functionality of digital terminal device 200 by accessing alternative application software programs contained within received digital storage media 1000.

In step 702 of process 700, in the present embodiment, prior to turning on digital terminal device 200, a user or subscriber inserts into media receiving apparatus 2000 a chosen media storage device 1000 which contains alternative application software programming to be implemented in digital terminal device 200.

In step 703 of process 700, in the present embodiment, the user or subscriber turns on digital terminal device 200 by pressing the power button, which is disposed upon the facial surface thereof.

In step 704 of process 700, in the present embodiment, once the user has applied power to digital terminal device 200, the contents of level 1 EEPROM 210 get loaded into SDRAM 230 at level 1 base address 0x00000000 and hence gets executed.

In step 705 of process 700, in the present embodiment, once loaded into SDRAM 230 at the specified address, level 1 EEPROM 210 then copies the entire content of flash memory 220, or at least the sections that contain boot loader program 222 and default application program 224, into SDRAM 230. Boot loader program 222 is loaded into SDRAM 230 at level 2 base addressable memory location 0x00400840 and default application program 224 is loaded into SDRAM 230 at level 2 base addressable memory location 0x00000804.

In step 706 of process 700, in the present invention, once boot loader program 222 and default application program 224 have been loaded into SDRAM 230, level 1 EEPROM 210 then jumps to the start of boot loader program 222, at memory location 0x00400840, and boot loader program 222 is executed. Once executed, boot loader program 222 checks to see if a media storage device 1000 has been inserted into media receiving apparatus 2000, and if one is present boot loader program 222 further checks to see if it contains a valid application software file.

Continuing with step 706 of process 700, in the present invention, if there is no media storage device 1000 inserted into media receiving apparatus 2000, or no valid application software file is present in the received media storage device, as in the negative response of step 707, the default application program 224, previously loaded into SDRAM 230 in step 705 is then executed in accordance with step 714. Otherwise, if boot loader program 222 finds that media storage device 1000 is present in media receiving apparatus 2000 and that the media storage device contains a valid application software file, in one embodiment the file is called BOOTAPPS.out, boot loader program 222 determines whether BOOTAPPS.out is applicable as a stand-alone application software program, step 711, or applicable as an upgrade or corrective application software, step 712.

In step 712 of process 700, in the present embodiment, if it has been determined that the BOOTAPPS.out file is applicable to the default application program 224 as upgrade or corrective application software, then the contents of the file are written to default application program 224 disposed within flash memory 220 at addressable memory location 0x00000000, in one embodiment of the present invention. After the BOOTAPPS.out file has been written to and becomes part of default application program 224, digital terminal device 200 is re-booted and process 700 begins anew.

In step 711 of process 700, in the present invention, if it has been determined that BOOTAPPS.out is applicable as a stand-alone application software program, then the contents of BOOTAPPS.out is copied to SDRAM 230 at level 2 base addressable memory location 0x00000804, step 713, which thereby overwrites default application program 224 previously written to the same location, as described in step 705 of process 700.

In step 714 of process 700, in the present embodiment, the application software program residing at SDRAM 230 level 2 base addressable memory location 0x0000840, either default application program 224 or that which was in BOOTAPPS.out is executed by processor 240.

In step 715 of process 700, in the present embodiment, once either application is executed by processor 240, it is then sent to the graphic block (not shown or described) which then displays to the user the chosen, default, upgraded, or corrected interface.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A media receiving system communicatively coupled to a digital terminal device, wherein said digital terminal device is a set top box configured with a default application program, said media receiving system comprising:
a media receiving apparatus coupled to said media receiving system which receives digital storage media, wherein said digital storage media is a memory stick; said memory stick containing alternative application software program to be used by said digital terminal device;
a media accessing mechanism coupled to said media receiving apparatus for accessing data contained within said digital storage media, once said digital storage media has been received by said media receiving apparatus; and
a relaying component coupled to said media receiving apparatus that relays said data contained within said digital storage media to said digital terminal device.

2. The system of claim 1 wherein said alternative application software program is configured as a stand-alone application software program, said stand-alone application software program adapted to be implemented in said digital terminal device instead of said default application program configured in said digital terminal device.

3. The system of claim 1 wherein said alternative application software program is configured as an upgrade application software program, said upgrade application software program adapted to be written into said default application program of said digital terminal device, such that said default application is thereby upgraded.

4. The system of claim 1 wherein said alternative application software program is configured as a corrective application software program, said corrective application software program is adapted to be written into said default application program of said digital terminal device, such that the portion of said default application program of said digital terminal device functioning improperly is corrected such that proper functionality is restored to said default application program.

5. A media receiving apparatus communicatively coupled to a digital terminal device, wherein said digital terminal device is a set top box configured with a default application program, said media receiving apparatus comprising:
an opening in said media receiving apparatus adapted to enable said media receiving apparatus to receive media;
a receiving mechanism coupled to said media receiving apparatus, said receiving mechanism adapted to receive said media, wherein said media is digital storage media;
an accessing mechanism coupled to said receiving mechanism, said accessing mechanism adapted to access data contained within said digital storage media, once said media has been received; and
a relaying component coupled to said media receiving apparatus, said relaying component adapted to relay said accessed received data to said digital terminal device, wherein said data is an alternative application software program to be used by said digital terminal device.

6. The apparatus of claim 5 wherein said digital storage media is a memory stick.

7. The apparatus of claim 5 wherein said opening of said media receiving apparatus is such that it is integral to said digital terminal device.

8. The apparatus of claim 5 wherein said opening of said media receiving apparatus is of a height and width to accept said digital storage media.

9. The apparatus of claim 5 wherein said alternative application software program is configured as a stand-alone application software program, said stand-alone application software program adapted to be implemented in said digital terminal device instead of said default application program said configured in said digital terminal device.

10. The apparatus of claim 5 wherein said alternative application software program is configured as an upgrade application software program, said upgrade application software program adapted to be written into said default application program of said digital terminal device, such that said default application is thereby upgraded.

11. The apparatus of claim 5 wherein said alternative application software program is configured as a corrective application software program, said corrective application software program is adapted to be written into said default application program of said digital terminal device, such that the portion of said default application program of said digital terminal device functioning improperly is corrected such that proper functionality is restored to said default application program.

12. In a digital terminal device, wherein said digital terminal device is a set top box configured with a default application program, a method for accessing and utilizing data contained within digital storage media, wherein said digital storage media is a memory stick, said method comprising the steps of:
a) receiving said digital storage media, said step a) performed by a media receiving apparatus, said media receiving apparatus communicatively coupled to said digital terminal device; and
b) accessing said data contained within said digital storage media, said step b) performed by an accessing mechanism coupled to said media receiving apparatus; and
c) relaying said data to said digital terminal device, said step c) performed by a relaying mechanism coupled to said media receiving apparatus, wherein said data is an alternative application software program to be used in said digital terminal device.

13. The method as recited in claim 12 wherein said step a) further comprises the step of:
a1) inserting said digital storage media into said media receiving apparatus.

14. The method as recited in claim 12 wherein said step a) further comprises the step of:
a2) applying power to the digital terminal device such that said digital terminal device is thereby turned on, once said digital storage media is inserted into said media receiving apparatus.

15. The method as recited in claim 12 wherein said step b) further comprises the step of:
b1) accessing said data contained within said digital storage media, said data containing said alternative application software program to be used by said digital terminal device.

16. The method as recited in claim 12 wherein step c) further comprises the steps of:
b2) said accessing of said data controlled by pre-existing instructions disposed within programmable non-volatile memory coupled to said digital terminal device; and
b3) said accessed data is disposed within the root directory of said digital storage media.

17. The method as recited in claim 12 wherein said step c) further comprises the step of:
c1) relaying said data containing said alternative application software program to said digital terminal device.

18. The method as recited in claim 12 wherein said alternative application software program contained within said data is adapted as a stand-alone application software program, said stand-alone application software program adapted to be implemented in said digital terminal device instead of said default application program said configured in said digital terminal device.

19. The method as recited in claim 12 wherein said alternative application software program contained within said data is adapted as an upgrade application software program, wherein said upgrade application software program is further configured to be written into said default application program of said digital terminal device.

20. The method as recited in claim 12 wherein said alternative application software program contained within said data is adapted as a corrective application software program be written into said default application program of said digital terminal device when said default application program is comprising faulty instructions preventing said default application program from functioning properly.
